(19) United States
(12) Patent Application Publication
(10) Pub. No.: US 2009/0134812 A1
(43) Pub. Date: May 28, 2009

(54) Exhaust fan for showing variable characters

(76) Inventor: Zheng-Kun Zhang, Taiepi (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/984,916

(22) Filed: Nov. 26, 2007

(51) Int. Cl. H05B 37/02; H01F 38/14

(52) U.S. Cl. 315/291; 307/104

(57) ABSTRACT

The present invention is related to an exhaust fan, particularly to a fan applied to a personal computer (PC) or computer's power source unit (PSU). The exhaust fan includes base, blade and a second printed circuit board (PCB). The second PCB is disposed on a surface of the blade. A set of induction generator disposed to a joint of the blade joined to the base is electrically connected to the second PCB as a loop. An induced alternate current (AC) turned into direct current (DC) powers the second PCB instead of the mother board power source. Therefore, the low profile fan can be added to the PSU for a low clearance installment.

### FIELD OF THE INVENTION

The present invention is related to an exhaust fan, particularly to a fan showing variable characters on computer or computer's power supply unit (PSU).

### BACKGROUND OF THE INVENTION

Usually, an exhaust fan applied to computer's PSU etc., is composed of a base, and blades. During usage of the fan, the blades are rotated to generate airflow more laminar and less turbulent; thus heat can be carried away by advection. But, fashion style of the exhaust fan is somewhat monotonous style, lack of aesthetic feeling.

Accordingly, our visual system can convert patterns of light into neuronal signals, by which an image of outer world may retain on our retina in the range of period from 1/16 second to 1/12 second; even visual perception stimulator is under condition of non-contingent presentation. Such “after image” related to “persistence of image” can be understood by a celebration firework displayed at night, flash patterns of explosive firework is substantially points of light retained on our retina for a temporary while, by which points of light is turned into continuous lines get caught by our visual system. Television (TV) or fluorescent tube produces visible light are substantially radiant glows emanated with a fluctuated frequency above 100 cycles per second. Due to afterimage phenomena, even film projection speed is sooner than shooting over 16 frames a second, pre-recorded events seem to display to perception as told or written about. Accordingly, motion capture of cartoon characters even in three dimensional (3D) animation manufacturing first can be divided into a series of discrete frames, and then projects the frames in a continuous operation; finally, the cartoon characters are moved in sight. Based on such principles, person skilled in the art have provided dynamic demonstration device such as U.S. Pat. No. 4,470,044 entitled “momentary visual image apparatus” to Bill Bell on Sep. 4, 1984 provided a linear demonstration device, it disclosed that a number of discrete light elements made to move to produce light in successive segments attuned to characteristic scanning motion of human eye, such as programmed “Hello” visual image is produced. Or as U.S. Pat. No. 6,222,459B entitled “Method of word screen formation by laser light projection and the structure for the same” to Chiu-Yu Ting on Apr. 24, 2001 provided a reciprocating demonstration device, similar to U.S. Pat. No. 4,470,044, it disclosed laser production devices arranged in a column and by rapid reciprocated deflection, but not linear projection, of the devices to project multiple columns, column by column, of light track and form word arrays within a human eye vision transient time. Or as U.S. Pat. No. 6,037,876 entitled “light message fan” to James C. Crouch on Mar. 14, 2000, it disclosed that a ceiling fan has a plurality of light sources associated with and overlies a respective image line, a plurality of positions are calculated for at least one of the light sources along the image line dependent upon the rotational speed to show programmed message pattern, where rotation speed of blades and travel time of lights between two adjacent positions are arranged to show, such as capital letter patterns.

Based on after image phenomena, some manufacturers add light emission diodes (LEDs) to exhaust fans for showing patterns, or logos to promote their products.

On the market, most fans decorated with LEDs for flashing patterns powered by changing magnetic flux to induce electric field and electricity according to Farady's Law as a power source. An installment space is required for propelling forced convection of air around the fan, which must be positioned at a normal stance. It results in a space-occupied computer could not be a reduced-dimension product.

Moreover, tiresome repetition of most LEDs glittering fans showing only fixed patterns, and characters may induce chronic fatigue syndrome to users.

### SUMMARY OF THE INVENTION

The present invention is to provide an exhaust fan for showing variable characters by controllable light emission diodes (LEDs) on a second printed circuit board (PCB); the exhaust fan is operated by electricity produced through mutual induction according to Farady's Law. Furthermore, the exhaust fan is set up as a low profile fan for low clearance installment.

The present invention is to provide an exhaust fan for showing variable characters comprising: a base, at least, a blade, and controllable light emission diodes (LEDs) on a second printed circuit board (PCB); said second PCB disposed on the blade, LEDs are arranged on a surface of the second PCB facing outward, characterized in that: a set of induction generator (a pair of closed solenoid coils and a permanent magnet ingot passed therethrough) disposed at a joint, where the blade is joined to the base, for inducing electricity, the set of induction generator is electrically connected to electric circuit on the second PCB on the blade to form a loop.

A controller on the second PCB determines a frequency for flashing the LEDs, a remote control device relative to the controller, and a receiver relative to the remote control device are also disposed on the second PCB.

Said remote control device is selected from one of the following: an infrared remote controller, a radio frequency remote controller, or a micro controller unit (i.e. universal serial bus (USB) controller).

Said second PCB includes remote data access, such as remote data service (DTS), multi-lingual digital display circuit, storage unit, rectifier, and filter, wherein the storage unit of variable capacity for storing different sets of frequencies for flashing LEDs to facilitate coincident frequency trials picking up by users for further showing multi-lingual characters timely.

Said set of induction generator induces electricity through a pair of solenoid coils made from enameled coppered wires, and a first permanent magnet ingot inserted through the pair of solenoid coils, wherein a second solenoid coil is fixed inside the blade, a first solenoid coil is fixed to a frame electrically insulated from a motor inside the base.

Logos, patterns and characters showing on the fan, but not hidden from view, a frequency coincidence for running sequential patterns in harmony with a synchronous rotation speed of the fan is required, a detector for monitoring an alternate speed or increment/decrement speed of the fan is added thereto, the detector includes an LED disposed on a first PCB of the fan, a corresponding photo sensitive resistor disposed to a second PCB above/opposite to the first PCB, or an infrared light emission diode (infrared LED, infrared transmitter) disposed to the first PCB of the fan, a corresponding infrared receiver disposed to the second PCB above/opposite to the first PCB, or a second permanent magnet ingot assembled to a frame electrically insulated from the motor, a corresponding magnetic sensor disposed to the blade.

Based on after image phenomena, through frequency coincidence trials on controllable LEDs locally disposed adjacent to each other, the LEDs can be glittered in sequence to retain a vision persistence on user's retina to form continuous patterns and characters, glittering frequency of the LEDs can be determined by the remote control device. A variable capacity of the storage unit allows the remote control device to implement different sets of frequencies for showing variable patterns or characters. Users can re-arrange the selected frequencies sequence for showing logos as required.

### ADVANTAGES OF EMBODIMENTS OF THE INVENTION

By embodiments of the present invention, advantages can be achieved as following:

The second PCB are fixed onto the blade, thus the blade is further distributed with LEDs and PCB arranged in symmetrical balance.

By mutual induction, a first solenoid coils disposed into the blade, and a second solenoid coils disposed to the frame, which is electrically insulated from the motor; a small space inside the joint, where the blade is joined to the base, are designed with space efficient implementation. A low clearance installment is possibly achieved for installing a low profile fan to the power supply unit (PSU) etc.

### BRIEF DESCRIPTION OF THE DRAWINGS

FIG. 1: a schematic assembled view of the fan.

FIG. 2: a diagrammatic view of the remote control device on the second PCB in operation.

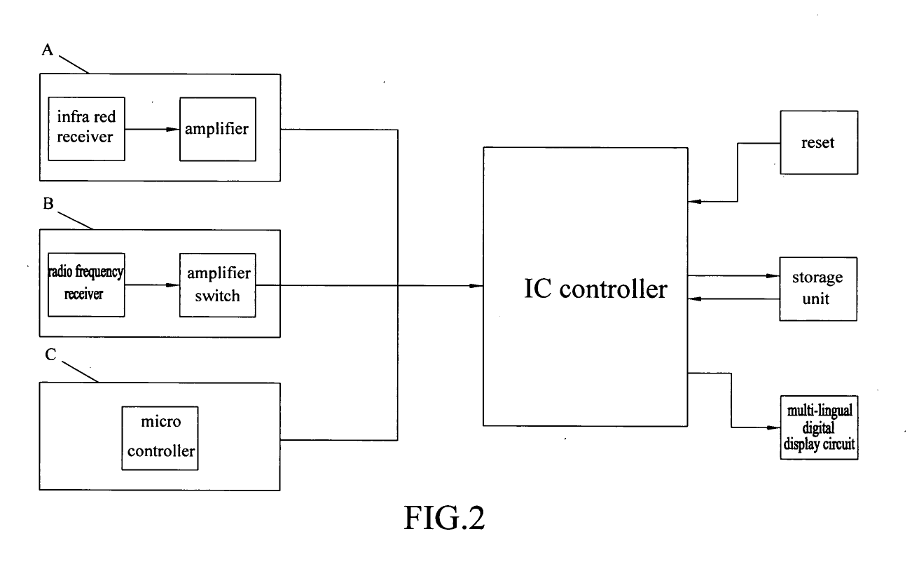

FIG. 3: a diagrammatic view of the wiring of the fan of the present invention.

FIG. 4: a diagrammatic view of electric wiring of multi-lingual display circuit.

### DETAILED DESCRIPTION OF THE PREFERRED EMBODIMENTS OF THE PRESENT INVENTION

The description is described in detail according to the appended drawings hereinafter.

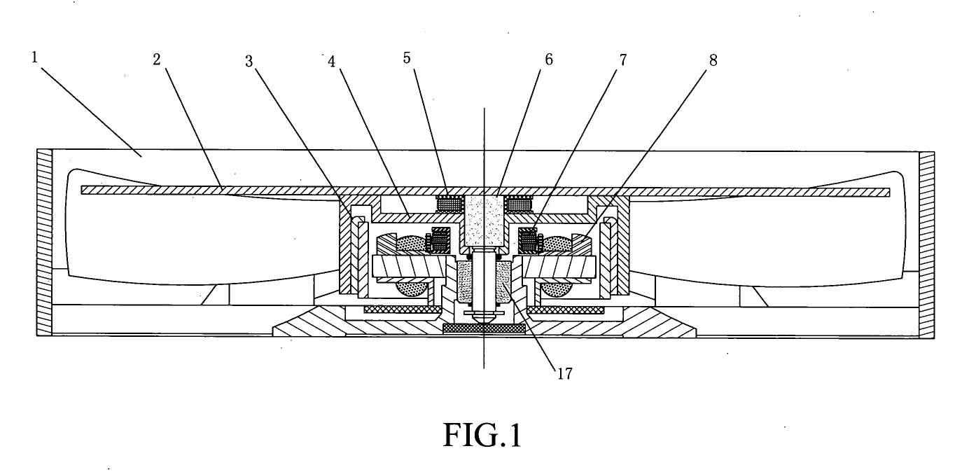

As shown in FIGS. 1˜2, the exhaust fan includes a base (1), and, at least, a blade (4). A hub (17) disposed inside a middle portion of the base (1) accommodates a shaft of the blade (4) to be anchored thereto. Thus the blade (4) can be rotated by the hub. A motor disposed inside a joint between the base (1) and the blade (4), once coils of the motor is electrified, the blades (4) can be rotated to generate airflow more laminar and less turbulent.

A second printed circuit board (PCB) (2) is coupled to a surface of the blade (4), a number of controllable light emission diodes (LEDs) disposed on an upper surface of the PCB (2) facing outward. A controller disposed on the PCB (2) determine a frequency for flashing the LEDs, further a remote control device relative to the controller is also disposed on the second PCB (2). The remote control device can be selected from one of the following: an infrared remote control device (A), a radio frequency remote control device (B), or a universal serial bus (USB) controller, namely, micro controller (C). An infrared receiver relative to the remote control device is also disposed on the second PCB (2). Said second PCB (2) includes remote data access, such as remote data service (DTS), multi-lingual digital display circuit, storage unit, rectifier, and filter; the storage unit of variable capacity storing different sets of frequencies for flashing LEDs to facilitate coincident frequency trials picking up by users for further showing multi-lingual characters timely by a user himself/herself.

A set of induction generator induces electricity rotates the blade (4) to generate airflow more laminar and less turbulent; thus heat can be carried away by advection. The set of induction generator consists of a first solenoid coils (7), a second solenoid coils (5), and a permanent magnet ingot (6) inserted through them. The second solenoid coils (5) is fixed inside the blade (4), while the first solenoid coils (7) is fixed inside a frame (8) electrically insulated from the motor, which is defined as a stator relative to the blade defined as a rotor for inducing electricity. The first solenoid coils (7) is electrically connected to a first PCB, where a pulse production circuit has been fabricated. When the first PCB electrically connected to a power source, by which the first PCB and the pulse production circuit are electrified, the latter generates a set of alternate current (AC) pulses in a cyclically repetitive mode, which further induces an alternative magnetic field about the first solenoid coils (7). With the first permanent magnet ingot (6) inserted through the first solenoid coils (7), the alternative magnetic field is induced to the second solenoid coils (5) thereabove. An induced alternate current (AC) is therefore generated from the second solenoid coils (5). A filter, and a rectifier for use in the induced AC electric circuit, and then an integrated circuit (IC) controller on the PCB (2) is electrified, each of the controllable LEDs are therefore flashing individually; finally, a continuous pattern can be shown.

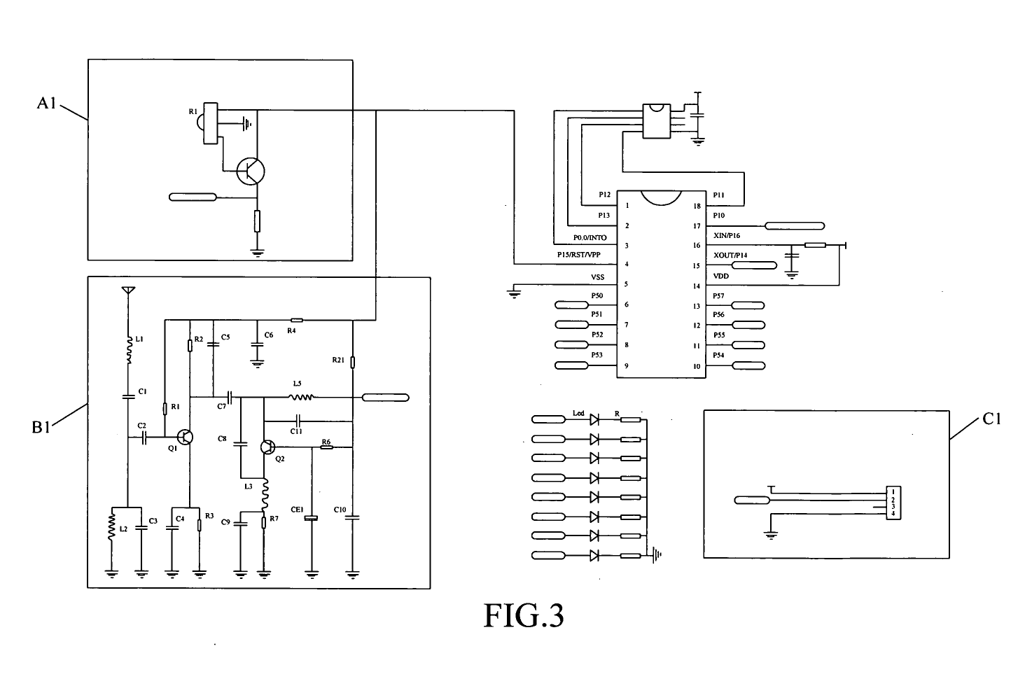

As shown in FIG. 3, electric wiring diagrams of three selective remote receiver is illustrated, in that, frame (A1) is an infrared receiver relative to an infrared remote controller (A), frame (B1) is a radio frequency receiver relative to a radio frequency remote controller (i.e. wireless remote control), frame (C1) is a remote receiver relative to a universal serial bus (USB) controller (i.e. Micro controller)

With glittering frequency of LEDs under control, each of the LEDs can be lit at locally disposed locations, whereby continuous patterns or characters can be shown as desired. Since the glittering frequency of LEDs can be alternated by the remote control device, a variable capacity of the storage unit allows the remote control device determines a sequence of different frequencies relative to different characters. Thereby, users can pick up trials of sequence for modifying and showing a required logo.

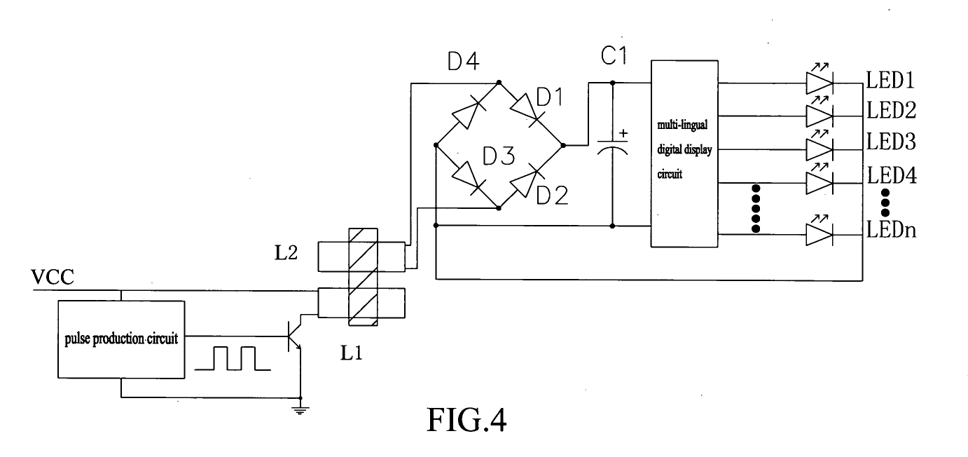

As shown in FIG. 4, the rectifier of the second PCB is constructed by diodes (D1, D2, D3, and D4) as a diode bridge or bridge rectifier, while the filter is composed of capacitor (C1) as a capacitance filter. An output from the filter can feed into the remote data access, such as remote data service (DTS), multi-lingual digital display circuit as an integrated circuit (IC), whereby the LEDs are under control for showing different characters and patterns. When the blade (4) is rotated, each of the LEDs is lit a longer while or a shorter while are under control to show a continuous pattern in sight, which is substantially constructed by the LEDs lit in time and in sequence. Variable patterns, logos can be shown.

By mutual induction, a pair of solenoid coils can be added to a joint between the blade (4) and the base (1). When the pulse production circuit is electrified, the second solenoid coils is electrified; as a result, the second PCB (2) is provided with an induced AC power source, which is transferred into direct current (DC) by the rectifier and filter. The DC is provided to the multi-lingual digital display circuit for controlling LEDs lit in place. Since LEDs are not electrified by a power source connected to the mother board of the personal computer or the like, the fan of the present invention is therefore can be realized as a low profile fan for a low clearance installment.

What is claim claimed:

1. An exhaust fan for showing variable characters comprising: a base (1), a blade (4), and controllable light emission diodes (LEDs) on a second printed circuit board (PCB) (2), said second PCB (2) disposed on the blade (4), LEDs are arranged on a surface of the second PCB (2) facing outward, characterized in that: a set of induction generator disposed at a joint, where the blade is joined to the base, for inducing electricity, the set of induction generator is electrically connected to electric circuit on the second PCB (2) on the blade to form a loop.

2. An exhaust fan for showing variable characters of claim 1 wherein a controller on the second PCB determines a frequency for flashing the LEDs on the second PCB, a remote control device relative to the controller, and a receiver relative to the remote control device are also disposed on the second PCB (2).

3. An exhaust fan for showing variable characters of claim 2 wherein said remote control device is selected from one of the following: an infrared remote controller, a radio frequency remote controller, or a micro controller unit.

4. An exhaust fan for showing variable characters comprising: said second PCB (2) includes multi-lingual digital display circuit, storage unit, rectifier, and filter, wherein the storage unit of variable capacity for storing different sets of frequencies for flashing LEDs to facilitate coincident frequency trials picking up by users for further showing multi-lingual characters timely.

5. An exhaust fan for showing variable characters of claim 1 wherein said set of induction generator is composed of a pair of solenoid coils (5, 7) made of enameled coppered wires, and a first permanent magnet ingot (6) inserted through the pair of solenoid coils, wherein a second solenoid coil (5) is fixed inside the blade (4), a first solenoid coil (7) is fixed to a frame (8) electrically insulated from a motor inside the base (1).

6. An exhaust fan for showing variable characters of claim 1 wherein a detector for monitoring an alternate speed or increment/decrement speed of the fan is added thereto, the detector includes an LED disposed on a first PCB of the fan, a corresponding photo sensitive resistor disposed to a second PCB (2) above the first PCB, an infrared light emission diode (infrared LED, infrared transmitter) disposed to the first PCB of the fan, a corresponding infrared receiver disposed to the second PCB (2) above/opposite to the first PCB.

7. An exhaust fan for showing variable characters of claim 1 wherein a detector for monitoring an alternate speed or increment/decrement speed of the fan is added thereto, the detector includes an LED disposed on a first PCB of the fan, a corresponding photo sensitive resistor disposed to a second PCB (2) above the first PCB, a second permanent magnet ingot assembled to the frame (8) electrically insulated from the motor, a magnetic sensor disposed to the blade (4) opposite to the magnet ingot.
